(19) United States
(12) Patent Application Publication
(10) Pub. No.: US 2003/0159555 A1
(43) Pub. Date: Aug. 28, 2003

(54) Thin wall singulation saw blade and method

(76) Inventor: Edward Robert Perry, Sedona, AZ (US)

Correspondence Address: John B. Sowell, 182 Midfield Road, Ardmore, PA, 19003-3213, US

(21) Appl. No.: 10/081,465

(22) Filed: Feb. 22, 2002

(51) Int. Cl. B26D 1/00; B26D 3/00

(52) U.S. Cl. 83/13

(57) ABSTRACT

A thin wall saw blade for cutting hard materials both clean and fast without clogging comprises a corrugated shaped electro-deposited matrix metal that encapsulate large diamonds so that the large diamonds have points or protrusions extending outward from the thin walls of the corrugated saw blade. The thin wall saw blade further includes small diamonds encapsulated inside the matrix metal. The density of the large and small diamonds by volume exceeds fifty percent so that the blade cuts fast and clean without clogging and is particularly well suited for singulating multi-layered substrates that include plastic and/or metal layers in or on the substrate.

### BACKGROUND OF THE INVENTION

1. Field of the Invention

The present invention relates to saw blades used to cut very hard materials. More particularly, the present invention relates to an improved diamond impregnated saw blade for use in singulation saws used in the semiconductor industry and is also useful in cutting large or small very hard objects.

2. Description of the Prior Art

Saw blades for cutting hard materials are well known. Such saw blades are made in the form of circular disc, gang saws and band saws. Circular saws may be made homogeneous comprising abrading material and a binder or may be constructed from a support disc with abrading material bonded onto the outer periphery. The outer periphery may be continuous or discontinuous. One of the purposes of providing a discontinuous pattern is that the grooves or passageways between the attached abrading material provides a resistance free passage for the outflow of abraded particles cut from the hard material and/or an associated coolant used to cool the saw blade as well as flush particles out of the blade.

Dicing saws are employed in the semiconductor industry to separate individual die one from another by cutting streets or separation channels into the wafer comprising a plurality of die. The smaller the die and the more narrow the street, the greater the yield of sawn die from a given size wafer. Further, the more narrow the streets, the greater number of die that can be made onto a wafer of a given size. For this and other reasons, wafer dicing saw blades are made very thin. Typical electro-deposited nickel diamond impregnated saw blades have been made in thickness from less than one thousandth of an inch up to several thousandths of an inch. When the die are packed very close on a wafer that is large, it is necessary that the dicing saw cut away the street material without chipping the edges of the die. Dicing saws of the type made by Kulicke and Soffa Industries and Disco Corp. provide the needed high degree of accuracy to cut large wafers into individual die without damaging the die. The individual die are packaged and/or connected to a substrate or carrier. Numerous types of carriers are used that fall into a category of Surface Mounted Technology devices, SMT devices. The substrates or PC Boards have circuits on or interleaved into the substrate which is a laminate having metal circuits, test circuits ground plane, etc. Once assembled on a substrate the now interconnected packaged device needs to be singulated or separated from other devices.

Some substrates have been singulated using thick dicing saw blades in dicing type saws because thin blades are destroyed by the metal layers in the substrate. Such thick blades require many hours to make, yet rapidly clog with plastic and metal from the circuits. The clogged blade then requires a greater force to make a cut and cuts slower because the diamonds that would do the cutting are less exposed. In addition, clogged blades have a tendency to make rough cuts which can smear or destroy the exposed circuit pattern especially when the smear occurs at a conductive pad or bump on the die.

Some substrates have been singulated using resinoid saw blades and/or sintered saw blades. Again the saw blade loads up with particles of plastic and metal and rapidly becomes unable to make a quality clean cut and must be replaced.

There is presently no known prior art type dicing saw blade or hard material saw blade that is self-cleaning and smooth cutting when used for singulating devices from substrates that have metal layers in the laminate being cut.

Further, there is no known prior art type dicing saw blade that does not clog with material so as to slow down the effective cutting speed.

Accordingly, it is not only desirable, but necessary to provide some type of blade for cutting hard material that can be used for singulation of devices from substrates and PC boards that is clean cutting and long lasting.

### SUMMARY OF THE INVENTION

It is a primary object of the present invention to provide a novel saw blade for cutting all types of hard material without clogging.

It is a primary object of the present invention to provide an improved diamond saw blade for sawing and/or drilling very hard materials.

It is a primary object of the present invention to provide a singulation saw blade that cuts smooth without clogging.

It is a primary object of the present invention to provide a method of making singulation saw blades that is cheaper than the prior art methods.

It is a primary object of the present invention to provide a method of making a uniform thick thin wall singulation saw blade that has a predetermined width of cutting blade.

It is a primary object of the present invention to provide a novel corrugated shaped singulation saw blade that cuts cleaner and faster than all known prior art singulation saw blades.

It is a primary object of the present invention to provide a thin wall saw blade with small protrusions or points of large diamonds extending from the sidewalls.

It is a primary object of the present invention to provide a thin wall saw blade that is by volume greater than fifty percent diamonds and comprises large diamonds and small diamonds encapsulated in a matrix of electroplated nickel.

It is a primary object of the present invention to provide a thin wall saw blade having a thickness that is thinner than the large diamonds that have exposed points extending from both sides of the wall of the saw blade.

It is a primary object of the present invention to provide a thin wall saw blade of electrodeposited nickel that can smear or deform behind encapsulated diamonds so that the diamonds are more strongly held by the matrix of nickel.

According to these and other objects of the present invention there is provided a novel corrugated shaped saw blade in the form of a cylinder, an annular ring or a flexible band for attachment to a carrier or for mounting on a hub or shaft. The blade comprises a thin wall of matrix material having a serpentine or corrugation shape that is three to ten times deeper in width than the thickness of the electroplated thin wall blade. The electrodeposited metal thin wall blade is virtually saturated with large and small diamonds which comprise in excess of fifty percent by volume and provide a longer wearing and faster cutting saw blade that is self-cleaning.

### BRIEF DESCRIPTION OF THE DRAWINGS

FIG. 1 is a plan view of a prior art annular ring shaped resinoid cutting blade made in a press with mating die;

FIG. 2 is a section in elevation of the annular ring shaped blade of FIG. 1 mounted in a flanged hub;

FIG. 3 is an isometric view of a prior art disc shaped cutting wheel made in a press with mating dies;

FIG. 4 is an enlarged partial section in elevation of an end portion of a prior art cutting wheel showing a super-abrasive mass attached to the outer perimeter of the wheel;

FIG. 5 is an enlarged partial section in side view of a cutting wheel like FIG. 4 showing a first layer of super-abrasive attached to alternate sides of the wheel which has been undercut to remove wheel material at the outer perimeter;

FIG. 6 is an enlarged partial section in side view of FIG. 5 after additional layers of super-abrasive have been added to complete the super-abrasive mass shown in FIG. 4;

FIG. 7 is a plan view of a thin wall plated corrugation shaped annular disc according to a preferred embodiment of the present invention comprising diamonds encapsulated in a nickel plated matrix;

FIG. 8 is an enlarged section in side elevation showing a thick cutting wheel comprising a plated thin wall corrugation annular ring;

FIG. 9 is a schematic plan view of a very large cutting wheel having a thin wall corrugated annular ring attached to a large disc;

FIG. 10 is an enlarged section in elevation taken at lines 10-10 of FIG. 9 showing a preferred method of attaching the annular ring to the large disc;

FIG. 11 is an isometric drawing of a machined mandrel or annular ring of the type employed to plate thin wall corrugated rings of various diameters;

FIG. 12 is a schematic drawing in side elevation of a drill pipe having a step down end adopted to receive a hollow cylinder of thin wall plated corrugation comprising diamonds encapsulated in a nickel matrix;

FIG. 13 is an enlarged schematic section in elevation showing a preferred cutting blade comprising a thin wall corrugation before cutting very hard materials;

FIG. 14 is an enlarged section in elevation showing the preferred embodiment cutting blade comprising a thin wall corrugation after cutting through very hard materials;

FIG. 15 is a block diagram of method steps employed to make one embodiment of a thin wall plated corrugated shaped annular disc for singulation saws; and

FIG. 16 is a block diagram of method step employed to make the preferred embodiment thin wall corrugation shaped elements for singulation saws, very large disc saws, band saws, etc.

### DESCRIPTION OF THE PREFERRED EMBODIMENTS

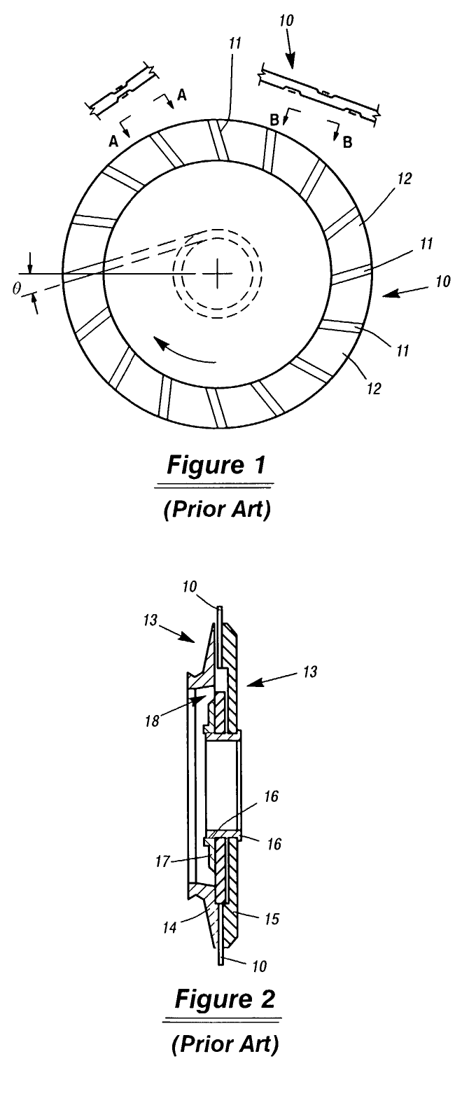

Refer now to FIG. 1 showing a prior art diamond impregnated resinoid cutting blade 10 used for cutting hard materials. In the embodiment shown, grooves 11 are pressed into the annular disc preferably as mirrored images on opposite sides leaving raised cutting teeth 12, as shown at A-A, but may be offset as shown at B-B. The reduced thickness blade is used for dicing wafers and has widths up to one-tenth of an inch thick. Cooling water is applied radially inwardly and is expelled by centrifugal force. A complete description of this blade is found in U.S. Pat. No. 5,479,911 and is incorporated by reference herein.

Refer now to FIG. 2 showing a flanged hub 13 of the type employed to hold and mount the cutting blade 10 of FIG. 1. The inner flange 14 and outer flange 15 are mounted on a support hub 16 and held by a clamping ring 17. When a cooling fluid is applied at the arrow 18, it is expelled out through the grooves 11 of annular cutting blade 10.

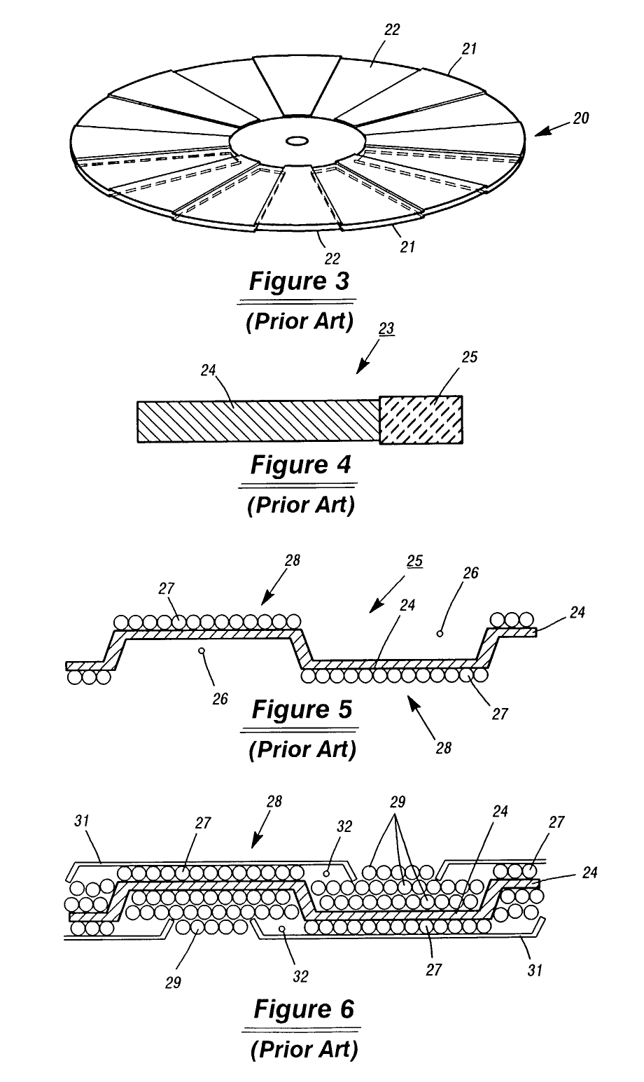

Refer now to FIG. 3 showing an isometric view of a prior art cutting wheel 20. The wheel is provided with a raised boss 21 on one side that is exactly opposite a groove 22 on the other side. The area of the cutting bosses 21 is made equal to area of the cleaning grooves 22 and the effective thickness of the wheel 20 is maintained the same. In one example, a 16-inch diameter wheel had a thickness of 0.122 inches with grooves and bosses of 0.014 inches. The standard wheel employed a resinoid binder of a mixture of ingredients using layers of mesh and grains of hard carbides. A complete description of this blade is found in U.S. Pat. No. 3,628,292 and is incorporated by reference herein.

The problem with the resinoid wheels or blades shown in FIGS. 1 to 3 is that they are known to clog up when cutting any material that include hard metals and plastics.

Refer now to FIG. 4 showing an enlarged partial section of a prior art cutting wheel 23 which comprises a supporting disc 24 to which a super-abrasive mass 25 is attached. The center 24 of the disc base member 23 is thinner than the mass 25 which is made by electro-depositing rows of individual super-abrasive particles.

Refer now to FIG. 5 showing an end view and detail of the mass 25 of FIG. 4 before it is finished. The grooves 26 have been cut in the center wheel. The grooves 26 are cut in the base member 24 at the perimeter. Particles 27 are deposited and bonded on the unmasked side, then on the opposite side leaving the wheel with peripheral raised bosses 28 of exposed diamonds 27. A complete detailed description of this blade is found in U.S. Pat. No. 6,098,609 and is incorporated by reference herein.

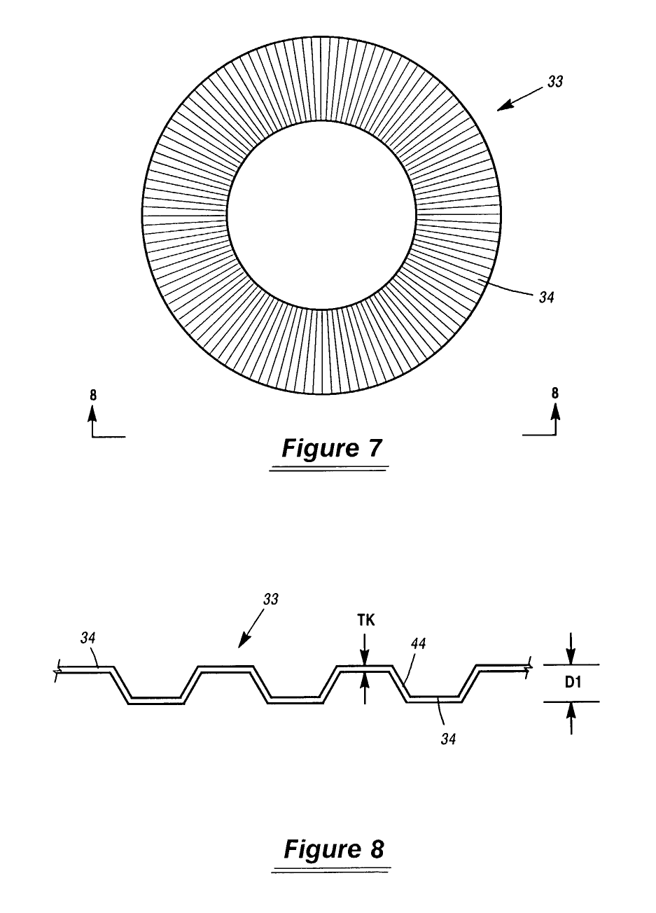

Refer now to FIG. 6 showing the wheel of FIG. 4 after the grooves 26 are filled in with rows of diamond to a level that coincides with the particles 27 of bosses 28. This prior art patent shows and describes three layers of the same size diamonds 29 built up in the grooves 26 of base member 24 while a mask 31 is provided over the diamonds 27 which formed the raised bosses 28 shown in FIG. 3. After the mask 31 is removed, the top rows of diamonds 29 comprise 6 rows of particles and leave a gap 32 of 3 to 4 rows between adjacent bosses 28. The supporting disc 24 was 6 mils thick and the built up mass 25 is shown to be about two-thirds deeper or thicker. Blades used for cutting a granite block are described as having a total abrasive thickness of 1.5 millimeters (i.e. approximately 60 mils).

The problem with prior art blade shown in FIGS. 4 to 6 is that the cutting edge mass 25 is made thicker than the base support 24 and requires a large number of machining steps, masking steps and deposition steps. When the edges of rows of diamonds 29 in the top layer are exposed they are more easily torn loose during a cutting operation. The same problem is presented to the edge rows of diamond in the bosses 27. Stated differently, the diamonds in the rows adjacent to the gap 32 have a tendency to tear loose and expose the next row, thus subsequently losing rows of diamonds which leads to clogging and slower cutting when used for singulation.

Refer now to FIG. 7 showing a schematic plan view of the present invention thin wall plated corrugated shaped annular disc blade 33 and to FIG. 8 showing an enlarged partial side elevation in section. In the preferred embodiment shown, the singulation blade 33 is made for use in a hub type fixture similar to hub 11 shown in FIG. 2. The thickness of the electro-deposited matrix ring 34 is preferably about 2 mils thick and is made thinner by six to eight microns than the thickness of the large diamond encapsulated in the matrix material which is preferably nickel. Thus, the points or raised edges of the large diamonds will be exposed by three to five microns in the preferred embodiment singulation saw blade. Since the thickness of the matrix material is about ten times the exposed height of the points of the single particle large diamonds, the encapsulated diamonds are held very firmly and do not have a tendency to tear loose at any place in the matrix. All diamonds are held by an optimum or maximum holding force which permits the novel singulation blade 33 to cut clean without clogging up to 4 inches per second cutting speeds which is higher than heretofore possible.

In the preferred embodiment, the thin wall matrix ring 34 of nickel was about two mils thick deposited on a reverse image mandrel forming a corrugation of uniform depth D1 about 10 mils deep. The depth D1 is approximately five to ten times the thickness of the matrix material. A corrugation of 120 grooves in a disc of 2 to 6 inches in diameter is flexible and self-flattening.

Prior art silicon wafer dicing saw blades have been made in thicknesses from 0.0007 inches up to about 0.001 inches. Such thin dicing saw blades are too fragile to be used for singulation. Such disc shaped blades had to be made increasingly thicker to be robust enough for singulation. Even then, the dicing saw single disc or annular ring type blade had a shallow depth of cut and it would clog up when attempting to cut epoxy-glass substrate PC boards. Some PC boards have seven or more layers of metal and/or copper in the substrate. New state of the art substrates now have injection molded encapsulating material covering the devices and cannot be cut using prior art thin matrix dicing saw blades.

The present invention singulation saw blade will cut clean without clogging all new type packages including epoxy glass substrates, ceramic and sapphire substrates as well as wafer level packaging, QFN and MLF packages which have added injection molded material and also contain metal layers.

The maximum depth of cut for prior art dicing saw type blades is about 0.25 inches. In contrast thereto the present invention blade is easily made in depths up to 0.50 inches and when mounted on very large disc and flexible blade band saws very large blocks of granite or metoriles may be cut in a single pass leaving a smooth polished surface. For example the height of the points of the large diamonds encapsulated in the nickel matrix can be controlled down to three to five microns which is considered to be a polished finish. Objects of hard material such a silicon nitride, silicon carbide, cubic boron nitride and sapphire (Al₂O₃), all having a hardness of 9.0 or above, may be cut smooth without clogging. Thus, composite objects made by pressing hard particles into a substrate with bonding metals are easily cut with the present invention diamond singulation saw blade. The only hard material that cannot be cut are diamonds or objects that include diamond particles such as sintered blades and diamond resinoid blades, etc.

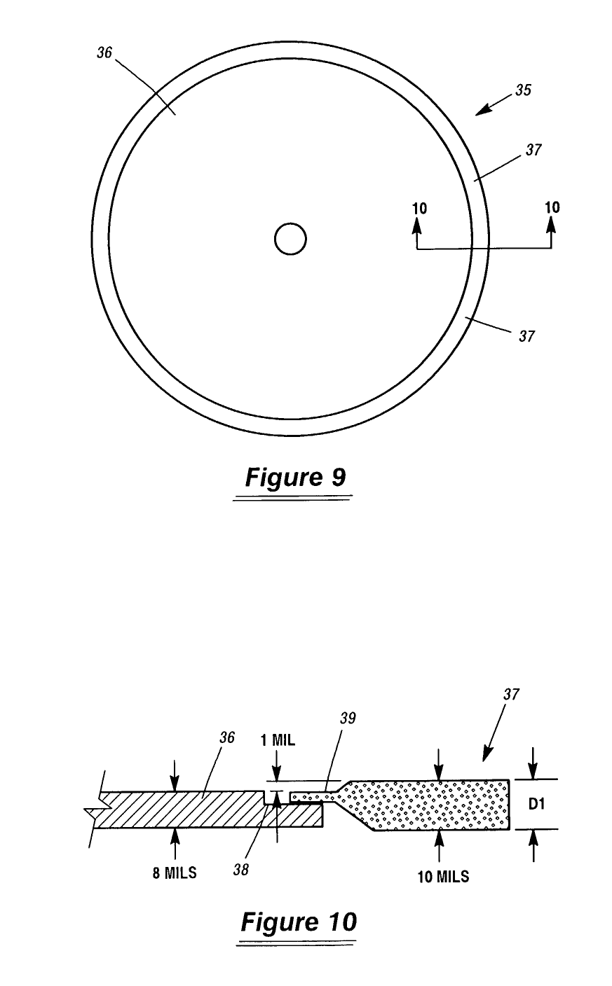

Refer now to FIG. 9 showing a plan view of a very large circular blade 35 having an edge or tip 37 made according to the present invention. The saw blade 35 comprises a thick metal blank or support 36 to which is attached an annular ring 37 that is corrugated as shown in FIG. 8. Such blades 35 are easily fabricated in diameters of four or more feet and will smooth cut all hard material objects without clogging.

Refer now to FIG. 10 showing an enlarged section in elevation taken at lines 10-10 of FIG. 9. The disc shaped support 36 is provided with a step-down annular ring-shaped shoulder 38 which is one mil deeper than the thickness of mounting flange 39 formed integrally with the annular corrugated singulation blade 37. In the example shown the depth D1 of the corrugation 37 is 10 mils which provide a clearance in the cut of 1 mil on each side of the support disc 36. The flange 39 may be attached to shelf 38 by numerous known welding techniques including spot or seam welding or by brazing or rod welding including tungsten inert gas (TIG) welding without a rod. Corrugated rings 37 may be made in existing nickel baths up to twenty feet in diameter.

Prior art disc of the type used to cut concrete, employ blades of the type shown and described with reference to FIGS. 1 and 3 where the whole disc is impregnated with diamonds or very hard particles. Such blades are limited in diameter size. Blades made in accordance with the teachings of FIGS. 1 to 6 also appear to be limited in blade speed whereas the present invention singulation blade or dicing saw blade easily operates at 15,000 to 30,000 RPM while cutting epoxy glass substrates with multiple layers of copper and/or steel lead frames. The blade will cut in a preferred or a reverse direction at four inches per second, which is about twice prior art cutting speeds. Further, the new blade cuts clean and polishes with or without cooling fluid.

Singulation and dicing saw blades are made in diameters of about two to six inches. The corrugations have an overall depth of five to ten mils. As a rule of thumb, the thickness of the nickel matrix is about one-fifth the depth of the corrugation. In the preferred embodiment singulation saw blades, the size of the large diamonds is greater by six to ten microns, however, blades approximately two mils thick have been made with a large diamond of thirty to fifty micron large diamonds and a sufficient number of points or protrusions of three to five micron height extend beyond the nickel matrix sidewalls to provide a clean cutting blade.

When blades are made for very large disc and band saw blades the depth of the blade is preferably made deeper and the large diamonds may be up to 300 microns in the center and the matrix or core is made twenty to fifty percent of the total depth of the corrugated blade. In such blades the diamond size may be forty to sixty percent of the thickness of the matrix or core.

For singulation and dicing saw blades the large diamonds are preferably in the range of thirty to fifty microns in size. For very large blades the diamond size may vary from twenty to 150 microns in size and by controlling the height of the protrusion, the novel corrugated blade cuts clean as it polishes.

In the preferred embodiment corrugated saw blade, the matrix contains about fifty percent by volume of small diamonds completely encapsulated in the electro-deposited and formed matrix and the large diamond comprise about twenty percent more diamonds by volume, thus the total concentration of diamonds may be about eighty percent by volume. This more than doubles the concentration of diamonds by volume of prior art singulation or dicing saw blades. It is believed that this higher density concentration of diamonds encapsulated in the thin wall nickel matrix results in longer wear at higher cutting speeds. The object being cut is not as hard as the diamonds. Blade wear occurs when diamonds are torn loose from the matrix.

In the prior art, clogging results in over heating and higher matrix temperatures which weaken the strength of the matrix and allows diamonds to become loosened. The end result would be slower cutting speeds to keep temperatures down. When blades clog, more pressure per unit area of cutting blade is required to maintain cutting speed. Users of prior art cutting blades are required to slow down the cutting speed and to reduce pressure to prevent fast wear and/or blade destruction.

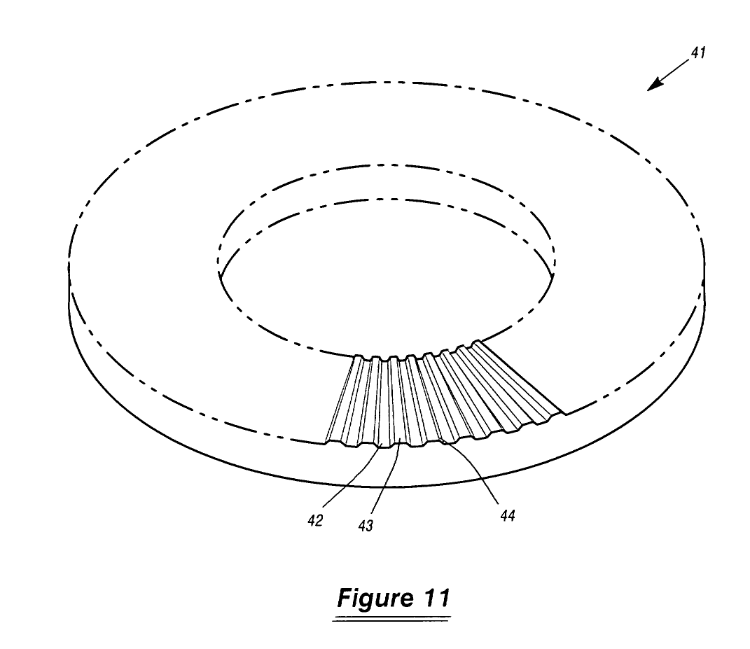

Refer now to FIG. 11 showing an isometric drawing of an electro-forming mandrel 41 having 120 raised surfaces 42 and 120 lowered surfaces 43. Such mandrels may be machined from stainless steel or formed from a moldable material and plated with a surface equivalent to stainless steel which does not require a release agent such as electro-conductive carbon. The U.S. aircraft industry employs plating tanks over twenty feet in diameter for making aircraft parts and forming dies, thus, all large blades may be made in a single continuous plating operation. The prior art blade shown and described in FIGS. 4 to 6 not only requires numerous sequential plating and masking operations, but by making a number of layers (five shown) the time has to be over five times a single matrix thickness blade made in corrugated form. In the preferred embodiment small singulation blade shown in FIGS. 7 and 8, the transition portion 44 is preferably forty-five degrees between surfaces 42 and 43. This enables the matrix ring 34 to be flexible and self-aligning when clamped in a hub or fixture. When the corrugated blade is made for large disc or for band saws, the blade may be deposited directly on the support disc or flexible band saw blade or made separately and attached as explained hereinbefore.

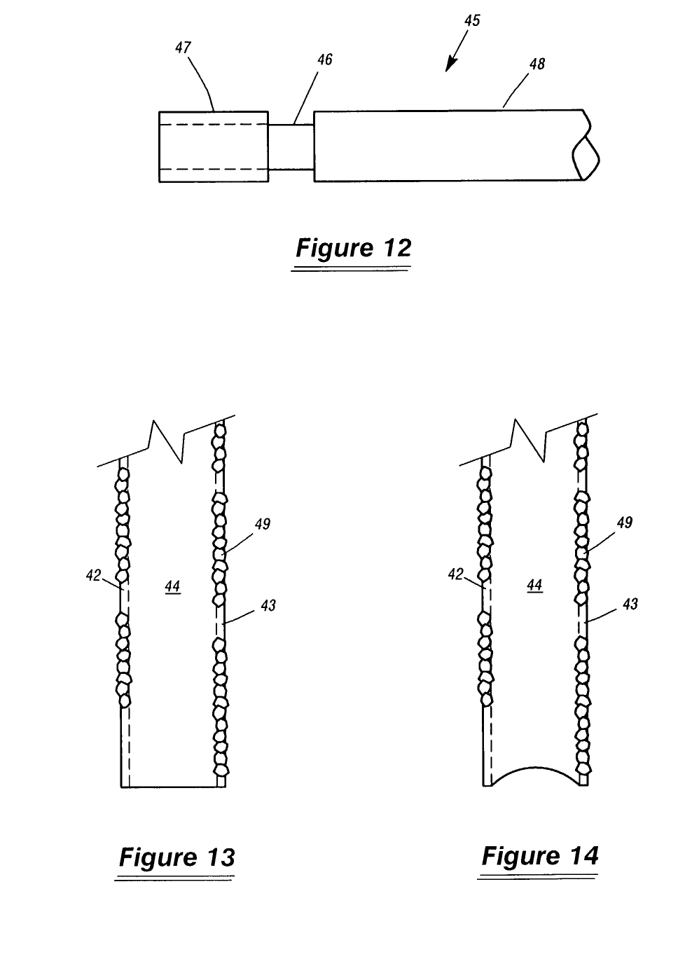

Refer now to FIG. 12 showing a schematic drawing in side elevation of a drill pipe 45 having a step-down end 46 adapted to receive a hollow corrugated cylinder 47 comprising a thin wall matrix of nickel holding a large concentration of large and small diamonds as explained hereinbefore. If the drill pipe is to be employed for extracting long cores of hard materials, the internal and external diameters of the pipe must have a larger I.D. and a small O.D. than the cylinder of diamonds encapsulated in nickel so that the core does not bind in the pipe. If the drill pipe is employed to cut through hard objects thinner than the length of the cylinder 47, the pipe or drill stem may be solid.

Refer now to FIG. 13 showing an enlarged schematic section in elevation taken through a thin wall corrugation of a cutting saw blade before cutting large amounts of hard material. The walls 42 and 43 correspond to upper and lower surfaces shown in FIGS. 8 and 11 and are connected by the transition piece 44. Ordinarily, diamond saw blades are dressed or run-in to provide a true diameter or edge. However, the wall or sides 42 and 43 comprise a concentration of about 80 percent large and small diamonds and any dressing tool other than a diamond would have difficulty affecting the shape. Accordingly, extreme care is taken in the manufacture of the thin wall corrugated matrix blade, and the start of a first cut comprises a high-speed test cut. If the blade is in round and balanced, cutting may be begun without dressing, otherwise, slow cuts are made until the blade dresses itself for high speed cuts up to 30,000 RPM and cutting speeds up to four inches per second on very hard to cut substrates.

Refer again to FIG. 12 and FIG. 13 both showing a preferred embodiment singulation blade before cutting and after extensive cutting, respectively. The large diamonds 49 are shown having points or protrusions that extend outward from the matrix wall. As explained hereinbefore, not all diamonds have to be thicker than the walls 42 and 43 to provide the preferred protrusion height of three to five microns from the side walls 42, 43 and transition wall 44. In one example a layer of copper 3 to 5 microns is deposited on the mandrel with the large diamonds 49. Then the nickel matrix is deposited on the copper with over fifty percent by volume of small diamonds not shown. Control plating is stopped before covering the top points of the large diamonds leaving a predetermined protrusion of 3 to 5 microns. The flash layer of copper is preferably removed before the blade is used for singulation. Other methods of providing equal protrusion on both sides of the bosses or surfaces 42 and 43 have been tried such as pressing the diamonds into a soft mandrel or a soft layer and then plating the matrix over the diamonds. Plating a soft removable layer first has advantages. In the broadest scope of the invention the large diamonds are introduced into the matrix first, followed by the small diamonds. When the high points on the large diamonds protrude a predetermined amount the plating is stopped and a usable blade is removed from the mandrel.

It will be noted that the walls 42, 43 and 44 all have the same density and concentration of large and small diamonds. The sidewalls 42 and 43 form a cutting disc a little less than 50 percent of a solid disc, whereas the transition portion forms a central intermediate disc of two thicknesses of the matrix material. There is one transition for each boss or portion of the wall 42 and 43, thus, the amount of matrix material in the center section is a fraction of that in the side wall. As shown in FIG. 14 the center transition wall 44 wears faster than the side walls 42 and 43. The concave end 48 is a preferred shape for singulation saw blades. The side walls 42 and 43 tend to wear uniformly flat so that minimum chipping occurs when the walls 42 and 43 break through the bottom surface of a substrate.

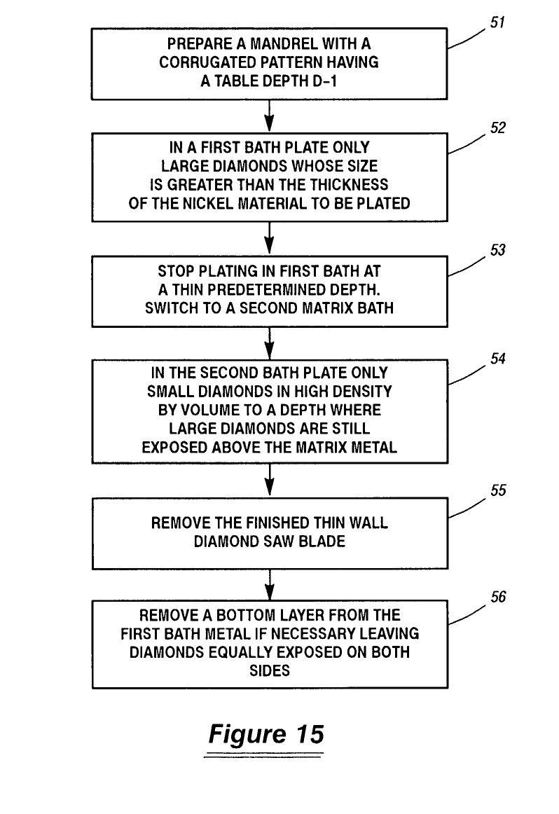

Refer now to FIG. 15 showing both necessary and optional steps employed in making one embodiment of a thin wall plated corrugated shape annular disc used in singulation saws. Blocks 51 through 56 are self-explanatory and provide one embodiment. It is possible to perform the plating steps in a single plating tank when the disc is small, however, this requires flushing the tank when switching to a different plating bath. It is easier to switch the mandrel to different plating baths and baths with different size diamonds. The inclusion of steps that are optional or those that may be performed differently does not detract from the broad concept of plating both large diamonds and small diamonds in the same nickel matrix to provide a thin wall corrugated singulation saw blade having a concentration of diamonds in excess of fifty percent. The protrusion of large diamonds from all walls 42 to 44 may be obtained by controlling the mandrel, the mandrel parting layer or a throw away layer while plating the matrix nickel as one continuous step.

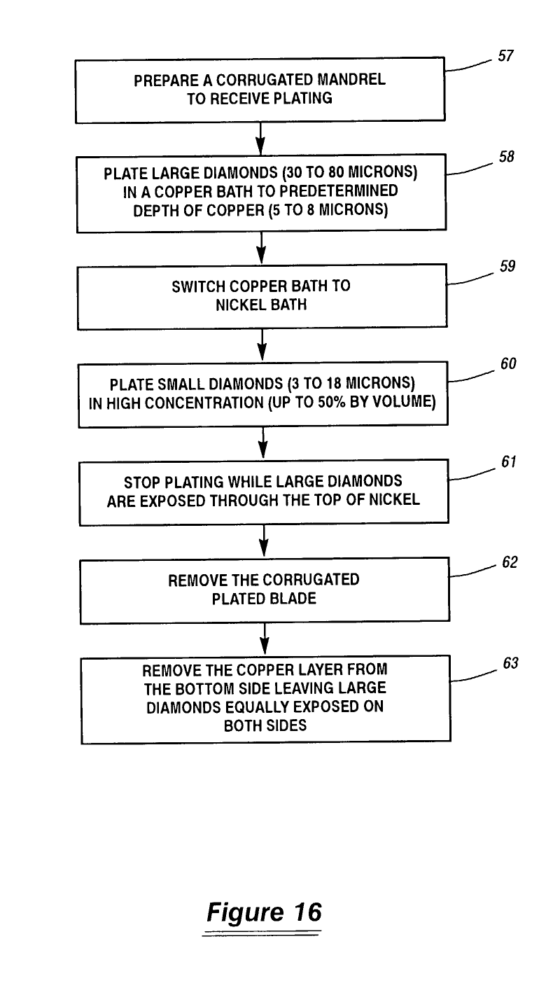

Refer now to FIG. 16 showing a block diagram of method steps which may be employed to make the novel thin wall corrugated shaped elements used for different types of singulation saws. As explained hereinbefore it is possible to substitute a parting layer for steps 58 and 59 which results in the elimination of step 63. The purpose of FIG. 16 is to explain in detail seven steps that have been employed to make the novel corrugated thin wall singulation saw blade that may be used as made or attached to support disc or band saw blades. When steps 58 and 59 are omitted the large diamonds are preferably plated on a special mandrel that allows large diamonds to protrude from the bottom wall or boss and the small diamonds may be plated in the same bath from which the large diamonds were plated.

Having explained the two complete methods of making the novel corrugated thin wall singulation saw blade and how each method may be modified to accomplish the equivalent end result it will be understood that numerous methods may be assembled from the steps of the methods explained with reference to FIGS. 15 and 16.

Thin wall diamond saw blades comprising diamonds are encapsulated into different hardnesses of a nickel matrix so that the cutting edge of the blades may withstand thousands of pounds of force per square inch of contract cutting area. No better way has been found than to make blades of different matrix metals and then test the blades under actual stress conditions.

As explained hereinbefore a blade that tends to clog cannot be used until it wears out because its useful cutting speed and ability to cut clean is lost before it wears out. The present invention saw blade cuts clean and does not clog and if properly used will simultaneously cut and polish any known hard material that can be cut with a diamond tool.

The present invention is capable of cutting speeds more than twice that of solid disc blades and may be employed in a forward or reverse direction and still cut clean without clogging even when cutting dry without cooling fluid which cannot be used on some types of substrates.

What is claimed is:

1. A thin wall singulation saw blade for cutting hard materials, comprising:
a plated nickel matrix for encapsulating large diamonds and small diamonds in the same matrix,
said nickel matrix having points of the large diamonds protruding from side walls beyond the small diamonds, and
said small diamonds being encapsulated inside the thin wall matrix in a high-density concentration.

2. A thin wall singulation saw blade as set forth in claim 1 wherein said thin wall of said matrix is serpentine or corrugated in shape and having a depth of corrugation which is 3 to 10 times the thickness of said thin walls of said matrix.

3. A thin wall singulation saw blade as set forth in claim 2 wherein the cutting area of matrix material in said side walls exceeds the total thin wall transition area between the side walls so that the side walls wear slower than the area between the side walls.

4. A thin wall singulation saw blade as set forth in claim 3 wherein the saw blade becomes concave at the cutting edge and the center of the blade becomes recessed between two parallel cutting side wall blades.

5. A thin wall singulation saw blade as set forth in claim 2 wherein said saw blade further includes a large circular metal blank, and
said matrix material is provided with an adapter portion for connecting the thin wall singulation saw blade to said circular metal blank.

6. A thin wall singulation saw blade as set forth in claim 2 wherein said saw blade further includes an endless flexible ribbon, and
said matrix material is provided with an adapter portion for connecting the thin wall singulation saw blade to said endless flexible blade.

7. A thin wall singulation saw blade as set forth in claim 2 wherein said saw blade further includes a drill rod or pipe, and
said matrix material is provided with an adapter portion for connecting a cylindrical thin wall singulation blade to said drill rod or pipe.

8. A thin wall singulation saw blade for cutting hard materials, comprising:
an inundating or corrugated shaped blade of substantially uniform thin wall thickness comprising a plated matrix material,
large diamonds encapsulated in the thin walls and having small points or protrusions extending from the thin walls on both sides,
small diamonds in the thin walls between and around said large diamonds,
said small diamonds being encapsulated in higher density by volume than said large diamonds, and
the depth of said inundations being greater than the thickness of said thin wall by a ratio of greater than three to one.

9. The method of making a thin wall singulation saw blade, comprising the steps of:
providing a mandrel having a corrugated shape,
plating a uniform thin wall of matrix metal in the presence of large diamonds,
initially plating enough matrix metal to entrap and hold the large diamonds in place,
substituting small diamonds for large diamonds,
plating and encapsulating the small diamonds in the matrix material,
ceasing plating of said matrix metal before points or protrusions of the large diamonds are covered, and
removing said thin wall corrugated shaped singulation saw blade from said mandrel with points of the large diamonds exposed and protruding through said thin walls.

10. The method as set forth in claim 9 wherein the step of plating a uniform thin wall of matrix metal comprises the step of limiting the uniform thickness wall to one third to one tenth of the depth of the corrugated shape.

11. The method as set forth in claim 9 which further includes the step of initially plating a copper layer in the presence of diamonds in the range of 50 to 80 microns, and
plating the copper layer to a thickness of 5 to 15 microns.

12. The method as set forth in claim 11 wherein the step of plating and encapsulating matrix metal comprises plating nickel in the presence of diamonds in the range of 3 to 18 microns, and
plating a nickel layer having a thickness less than said large diamonds.

13. The method as set forth in claim 9 wherein the step of plating a uniform thick wall of matrix metal comprises the step of plating a corrugated annular ring saw blade for use in a flanged clamping hub.

14. The method as set forth in claim 13 which further includes cooling the side walls of said corrugated saw blade with water when cutting.

15. The method as set forth in claim 9 which further includes the step of providing an attachment tab or flange on said thin wall saw blade, and
attaching said thin wall saw blade to a carrier or support.

16. The method as set forth in claim 15 wherein the step of attaching said thin wall saw blade to a carrier comprises attaching the flange to a hub, disc, rod or flexible blade.
